(19) United States
(12) Patent Application Publication
(10) Pub. No.: US 2021/0346736 A1
(43) Pub. Date: Nov. 11, 2021

(54) Reusable Face Mask with Changeable Filters

(71) Applicant: Vikram Ravikumar, New York, NY (US)

(72) Inventor: Vikram Ravikumar, New York, NY (US)

(21) Appl. No.: 17/225,979

(22) Filed: Apr. 8, 2021

Related U.S. Application Data
(60) Provisional application No. 63/007,311, filed on Apr. 8, 2020.

(51) Int. Cl. A62B 23/02; A41D 13/11; A62B 18/08

(52) U.S. Cl. CPC A62B 23/025; A62B 18/084; A41D 13/1107

(57) ABSTRACT

A reusable face mask including a face protector covering the user's nose, mouth, portion of cheeks and portion of chin. The face protector having an opening over the mouth and a raised or higher profile along the periphery of the opening. A filter within a filter housing is connected to the face protector over the mouth opening. The filter itself may be changed out after use while the rest of the face mask is reusable. A securing means is included for the reusable face mask to be secured to the user's head. The reusable face mask has a comfortable yet tight fit over the user's face.

### RELATED APPLICATIONS

The present application claims priority from Provisional Application Ser. No. 63/007,311 filed Apr. 8, 2020 and entitled “Reusable Face Mask with Changeable Filters”, the entire contents of which are hereby incorporated herein by reference for all purposes.

### BACKGROUND OF THE INVENTION

### I. Field of the Invention

The subject invention is directed generally to a system for respiratory filtering, and more particularly, to a system including a reusable face mask that can be washed and/or sterilized when not in use, apertures capable of connection to a filter which includes a portion that is disposable and/or capable of sterilization for reuse.

### II. Background of the Related Art

Masks have been used to filter out respiratory irritants as well as contagious diseases. Surgical masks are known to protect the patient from any droplets or pathogens emitting from the medical professional's mouth and nose and thus protect the patient. Other masks are known such as the N-95 used by medical professionals to protect themselves from contagious diseases and by contractors and construction workers to protect them from small particulates going into their mouth, nose, esophagus, general nasal path and respiratory system.

Masks were used in the Influenza pandemic in 1918 to filter out the virus and to protect individuals. Due to the global pandemic of 2020, general populations were under Executive Order or other regulation to wear a face mask covering the individual's mouth and nose in the effort to “flatten the curve” and reduce the spread of COVID-19. Due to a shortage of masks, medical staff were advised to reuse otherwise disposable masks such as surgical masks and N95 masks. A shortage of masks and other personal protective equipment (“PPE”) was evident in hospitals, medical facilities, labs, and any front-line worker situation. Some medical staff were given one mask per week and told to spray their mask at the end of each day with a disinfectant spray then place the mask in a paper bag to protect it from further contamination. Other medical facilities set up disinfectant rooms to hang used masks in an attempt to “clean” them with sprays, UV lights or other means to disinfect or even attempting to sterilize used masks made of woven materials, non-woven materials and the like.

Some of the problems with cloth, fabric, woven and general masks such as surgical masks and N95s are they can become saturated with live viruses, pathogens, bacterium, or other microorganisms attached to the fabric surfaces. The masks are also wetted or dampened by the natural exhale of the user through their mouth and nose. Once the mask is moistened by the exhale of the user the efficacy of the filtering properties of the mask are compromised and the mask has to be replaced. For many individuals, they may go through multiple disposable masks per day depending on their work environment such as heat and humidity in the workplace, exertion of the user causing sweat inside the mask, and amount of exhale resulting in moisture inside the mask. The environmental issues with disposable masks floating in the oceans, rivers and other waterways has increased in 2020 due to the global pandemic and the overall increase of use of such disposable cloth or fabric masks due to the COVID-19 pandemic.

Many individuals have tried to be environmentally friendly by reusing their cloth or fabric masks, but reuse without sufficient cleaning is harmful to the user as the virus or pathogens can build on the mask if reused over a period of time. It is recommended by health officials to wash a used or contaminated cloth or fabric mask but common consumer-grade laundry detergents do not contain disinfectant. Indeed, by washing the used contaminated cloth or fabric mask the user may unknowingly spread virus particles or pathogens in the wash and can contaminate other laundry in the washing machine as well. Thus, the reusable cloth and fabric masks may be more environmentally friendly but may not be as healthy as needed during a contagious disease outbreak or a global pandemic.

Further, these cloth or fabric masks such as the surgical mask only provide basic protection in front of the mouth and nose due to gaps around the masks on the side of the face such as the cheeks. Particulates, virus droplets, pollutants, and pathogens can enter the mask area through these gaps and into the users mouth or nose even when wearing a mask. Great effort has been made in public service advertisements in 2020 and 2021 to remind people that the mask must be tight fitting without any gaps at the nose, mouth and side of the face. Some medical experts have suggested users wear two masks on top of each other to better filter the air when breathing. The lack of gaps and making sure the mask is tight fitting and conforms to the nose and side of the face is for the individual's protection, but results in a very claustrophobic feeling and users complain they feel they cannot breathe.

In an effort to filter out virus and pathogens, masks have been created which are thicker or more dense. This has led to certain materials being used which may assist in high efficiency filtering. Due to the extra resistance imposed by the material, the user has to breathe considerably harder than they normally do without the mask. Thus, it is quite difficult for anyone to use such a mask comfortably for a prolonged period. Again, the natural exhale of the user then adds to the moisture of the mask. All of this increases the feeling of claustrophobia and inability to breathe by the user. In addition, the higher the efficiency of the filter media, the higher the flow resistance it will impose, thus making these masks even more uncomfortable for prolonged use. Such effects are particularly obvious for those who have weak or impaired respiratory systems, including the elderly, young children, and the sick, including asthmatics and COPD patients.

Beyond virus protection, other uses for masks include filtering out pollution and other particulates. In bigger urban areas the heavy density of cars, buses, trucks and motorcycles often emit excessive amounts of toxic pollutants. Manufacturing plants are another key source of pollutions. Natural or man-made disasters, such as sandstorms, fires of any kinds, also cause individuals to wear a mask to filter out the pollutants and particulates.

A mask that is reusable, safely, while offering comfort so that individuals (both medical professionals and non-medical individuals) will wear the mask all day as required depending on their environment is needed. A need exists for a reusable mask that has removeable filters so that the filters can be exchanged when used and a new clean filter inserted into the mask. A need exists for a mask that individuals will use that has reduced moisture on the inside of the mask resulting in increased use by the individual rather than stopping use when the inside of the mask gets too moist and uncomfortable. A further need exists for a reusable mask with a filter wherein the filter is not too dense or heavy so as not to impede the user's feeling of being able to breathe freely. These and other needs are met by the inventive reusable mask with removeable filters.

A need exists for a product such as a face mask which is form-fitting while also being reusable and allowing for changeable filters. Currently high-efficiency masks or respirators are in limited supply and expensive and even front line medical workers are being asked to reuse disposable PPE due to unavailability. A need exists therefor for a high-quality reusable mask that can utilize changeable and potentially less expensive filter material that is efficient enough to filter or prevent particles or virus, bacteria or liquids from getting through the mask. Many current masks are not formfitting enough to provide adequate protection for airborne viruses, bacteria, pollutants or other harmful things. A need exists for a reusable face mark with changeable filters combining both high-quality fit and low-cost changeable filtration materials.

The apparatuses, methods, assemblies and systems of the subject invention provide benefits and advantages that may overcome a number of problems with respect to known masks, particularly the problems that arise due to the difficulty of reusing the mask.

### BRIEF SUMMARY

The inventive reusable mask includes a form-fitting portion for use on the face such as a face protector and a filter housing for exchange of filters. The filter housing is connected to the face protector through a connecting means such as snaps, apertures, levers, straps, tabs, connectors, screws or the like. The face mask has straps or other means to secure the mask to the user's face, such as ear loops or a loop going around the back of the head.

Other aspects, features, and advantages of this technology will become apparent from the following detailed description when taken in conjunction with the accompanying drawings, which are a part of this disclosure and which illustrate, by way of example, principles of this technology.

These and other aspects of the contacts of the subject invention will become more readily apparent from the following description taken in conjunction with the drawings.

### BRIEF DESCRIPTION OF THE DRAWINGS

So that those having ordinary skill in the art to which the subject invention pertains will more readily understand how to make and use the apparatuses of the subject invention, preferred embodiments thereof will be described in detail herein below with reference to the drawings, wherein:

FIG. 1 is embodiment of the present invention showing the inventive reusable face mask with changeable filter apparatus in use on the face of a person;

FIG. 2 is the face mask portion of the embodiment shown in FIG. 1 without the changeable filter portion;

FIG. 3 is the changeable filter portion of the embodiment shown in FIG. 1;

FIG. 4 is another embodiment of the present invention of the reusable face ask with changeable filter on the face of the user without the changeable filter portion;

FIG. 5 is a close up side perspective view of the embodiment shown in FIG. 4;

FIG. 6 is a top view of the filter of the embodiment shown in FIG. 4;

FIG. 7 is a side perspective view of another embodiment of the present invention of the reusable face mask with changeable filter including tabs on the filter housing;

FIG. 8 is a side view of the filter housing and filter of the embodiment shown in FIG. 7;

FIG. 9 is a side view of the face mask portion including tabs of the embodiment shown in FIG. 7.

FIG. 10 is another embodiment of the inventive face mask with another embodiment of the connecting means and changeable filter.

FIG. 11 is a cut-away view of the filter inserted over and onto a tab of the face protector of the embodiment of FIG. 10.

FIG. 12 is a cut-away view of the filter housing inserted over filter and onto a tab of the face protector of the embodiment of FIG. 10.

FIG. 13 is another embodiment of the present invention of a replaceable filter including a filter within a filter housing having a number of tabs on the face protector.

FIG. 14 is another embodiment of the present invention of a reusable face mask including a snap-on filter housing over the top of the face protector with the filter in between.

### DETAILED DESCRIPTION

Preferred embodiments of the subject invention are described below with reference to the accompanying drawings, in which like reference numerals represent the same or similar elements. One of ordinary skill in the art would appreciate that while the apparatuses discussed herein relate to face masks, the scope of the invention is not limited to those exemplary applications and may be sized and shaped for the face where filtration of air is needed.

The subject invention provides an apparatus for filtration for a person's face and provides a reusable and more comfortable mask than current face masks. The subject invention provides a system for reusing a face mask so as to be environmentally friendly and cheaper while also including a changeable filter for health and safety reasons in filtering out virus, pathogens and pollution or any particulate in the air. The system is provided in a manner that is safe, comfortable, more practical, more mobile, convenient, effective, and usable by the individual.

The present invention provides a form-fitting reusable face mask 100 that allows for changeable filters. The invention is a high-quality reusable mask 100 that can utilize changeable and potentially less expensive filter material that is efficient enough to filter or prevent particles of pollutants, virus, bacteria or liquids from getting through while allowing the user to wear the inventive face mask comfortably for long periods of time with less moisture forming inside of the inventive face mask 100. The inventive face mask 100 combines both will allow for high-quality fit and low-cost changes of filtration materials.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” would include a plurality of such stimuli and reference to “the signal” would include reference to one or more signals and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may differ from the actual publication dates which may need to be independently confirmed.

The following description is provided in relation to several examples which may share common characteristics and features. It is to be understood that one or more features of any one example may be combinable with one or more features of the other examples. In addition, any single feature or combination of features in any of the examples may constitute additional examples.

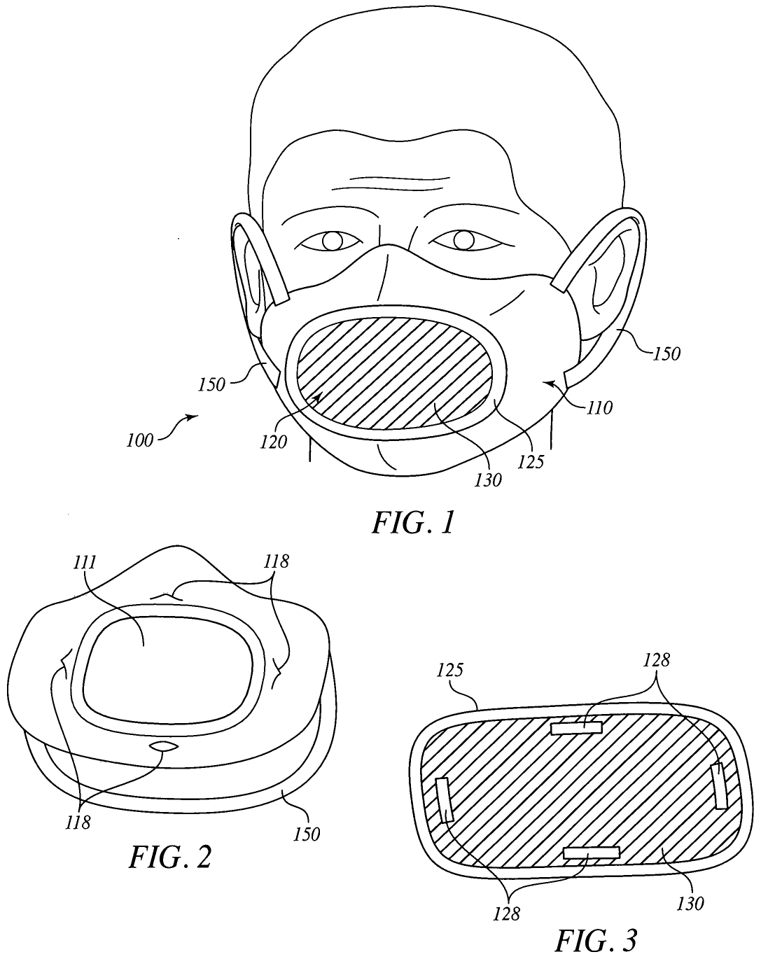

FIG. 1 illustrates an embodiment of the present invention namely a reusable face mask 100 including a replaceable filter 120 connected to a face protector 110 and a securing means 150 connected to the face protector 110 for securing the inventive reusable face mask 100 to the user. The face protector 110 is an exemplary mask that covers a user's nose and mouth. Other mask types may be employed that cover more or less of the user's face. For example, the face protector 110 could cover only the nose or the mouth or be expanded to cover the user's eyes. The face protector 110 may be configured in these examples as shown in FIGS. 1-2, 4-5, 7 and 8 to cover the user's mouth and nose and a portion of the cheeks and chin though again any configuration me be employed.

The face protector 110 may be made of any semi-flexible material such as by way of non-limiting example only, silicone, polymers, non-woven materials and the like. As the face protector 110 is in contact with the skin of the user the materials must be compliant with standards so as not to irritate the skin. In one example the face protector 110 is made of silicone which is semi-flexible and creates a snug fit to the face of the user when placed on the face. It is important to create a tight seal on the face of the user so that there are no gaps where particulates can enter into the inside of the mask such as pathogens, pollutants, virus, droplets and the like. The semi-flexibility of the silicone face protector 100 ensures the face protector will fit along the face of the user without any gaps while also being capable of sterilization after use, so that is it reusable. An example of a face protector 110 is made of a soft silicone that is comfortable to wear and creates an airtight seal with a user's face.

The face protector 110 has a connecting means 140 to connect the face protector 110 to the replaceable filter 120. In some examples the replaceable filter 120 is comprised of a filter housing 125 configured for a filter 130 to be inserted therein. The filter housing 125 is configured to connect to the face protector 110 without any gaps to keep out any particulates such as pathogens, pollutants, virus, droplets and the like. The filter housing 125 may be made of any rigid or semi-rigid, or semi-flexible material that hold shape and do not create gaps at the connection point with the face protector 110. The filter housing 125 may be made of polymers by way of example only.

The replaceable filter 120 includes a filter 130 which filters out particulates from the inside of the mask such as pathogens, pollutants, virus, droplets and the like. The filter 130 is disposable and can be replaced as needed. Because of the shape of the face protector 110 with a portion lifted away from the nose and mouth of the user, the filter 130 may not become as moist as quickly as other face masks which have a closer profile to the mouth and nose of the user. Based on the height profile of the side of the face protector 110 it is opined that the filter 130 will remain drier for a longer period of time than a face mask with a lower side profile and therefore the user will remain both comfortable wearing the inventive face mask 100 and will also feel easier to breathe overall with the space between the filter 130 and the user's mouth and nose. Further the higher profile of the side of the face protector 110 assists in airflow which supports improved nose breathability which in turn may lower blood pressure and individuals' heartrates during the stress of being in public during a contagious disease outbreak or global pandemic.

In some embodiments the removeable filter 130 may have a single active surface or a double active surface or multiple active surfaces. The filter 130 may be optimized to filter out small particulates. The filter 130 may also be treated with substances that reduce virus or bacteria growth such as anti-bacterial materials. In other embodiments the filter 130 may be treated with antimicrobial substances, bleach, disinfectants, salt and the like. The filter 130 may be made of a material which is less porous to reduce moisture inside the inventive face mask 100 when the user exhales in normal use. Further the filter may be multi-ply materials or melt blown fabric materials. The filter 130 may also be made of a material such as polypropylene or other non-woven fabrics capable of filtration of particulates.

The possible connecting means 140 between the replaceable filter 120 and the face protector 110 are numerous. By way of non-limiting example only, the connecting means may be snaps, O-rings, clips, threads, levers, lever presses, straps, screw, tabs, buckles, and the like. In one embodiment, the connecting means 140 is at least one or preferably two or more apertures 115 on the top of face protector 110 which is joined to tabs 126 on the filter housing 125. In another embodiment of the present invention the connecting means are snap-in constructs configured to enable the snapping in of various straps, cords, tubing, and/or O-ring stock.

As seen in FIGS. 2 and 3, the connecting means 140 is the joining of apertures or openings 128 placed onto tabs 118 on the face protector 110. The apertures or opening 128 are joined to the tabs 118 by force or pressure, thereby snapping them together. As seen in FIG. 8, the connecting means 140 are latches 113 that are inserted into the apertures or openings 127 on the filter housing 125. Other known connecting means such as clips, snaps, screws, hooks, buckles, or the like may be employed. Any connecting means that a wearer can use easily which creates a tight connection between the face protector 110 and the filter housing 125 or the replaceable filter 120 may be employed.

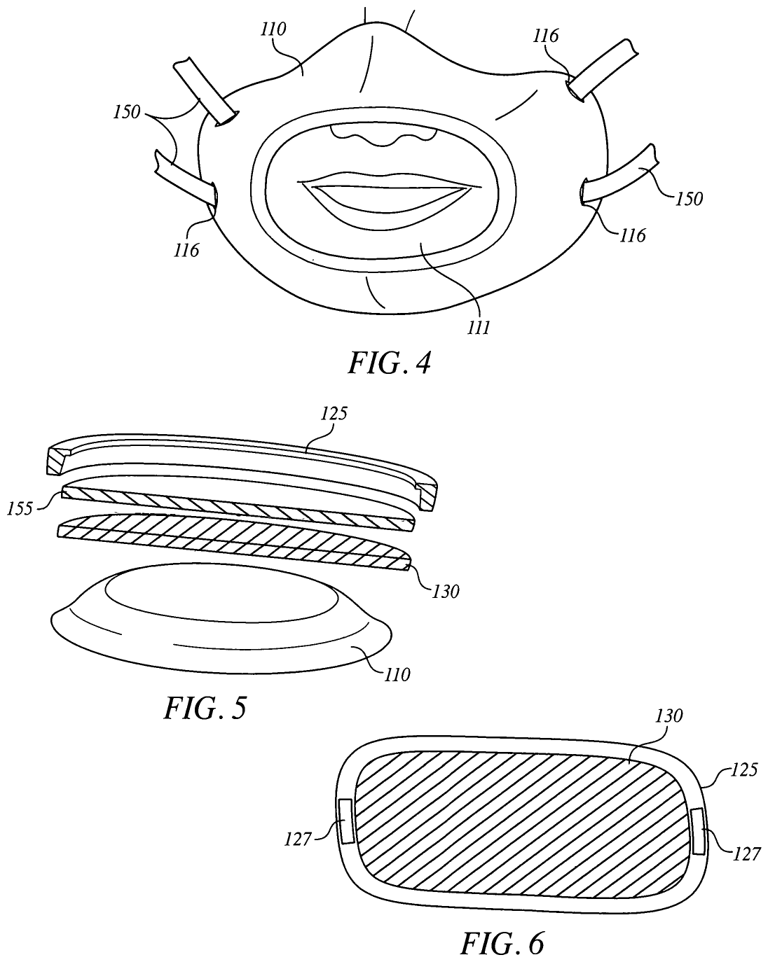

In another embodiment of the present invention as shown in FIGS. 4-6, the connecting means 140 is an O-ring 155 in between the filter housing 125, the filter 130 and the top of the face connector 110. The O-ring 155 connects in this embodiment as well as another embodiment employing a level system. The O-ring 155 connects the filter housing 125 with the top of the face protector 110 when the lever is in the closed and sealed position. The lever is then moved so as to dis-connect the face protector 110 from the filter housing 125 for removal of the used filter 130 and replacement with a new filter 130. In this embodiment the filter 130 may be placed within the filter housing 125 itself or in between the filter housing 125 and the face protector 110.

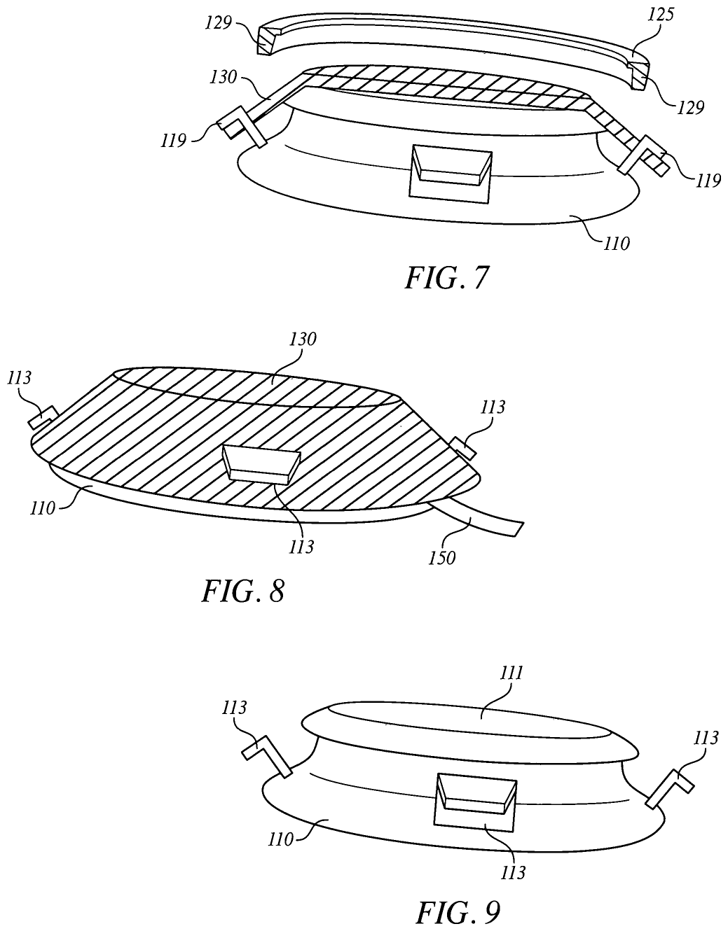

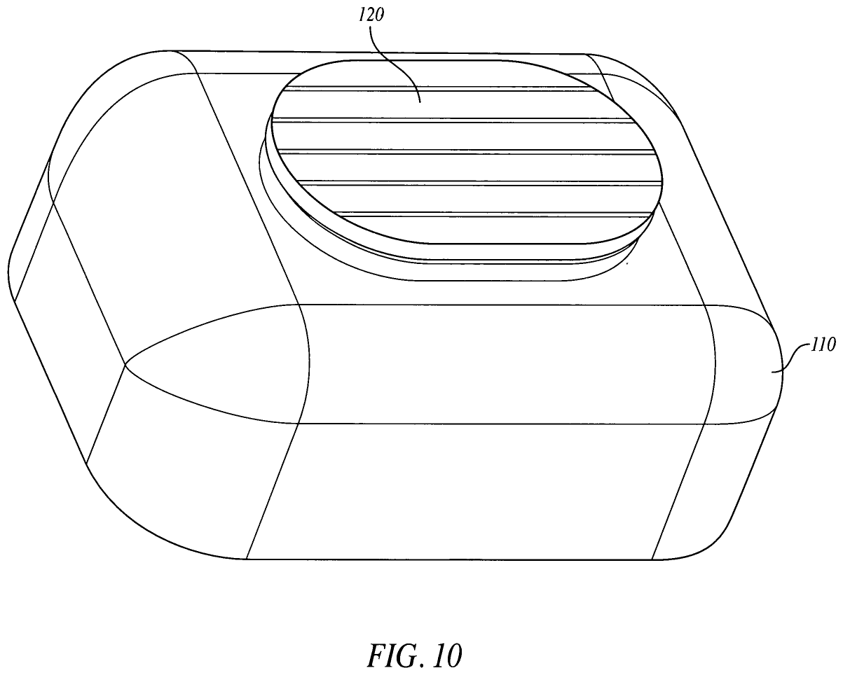

In another embodiment of the present invention, the connecting means 140 is a snap-on connection where on the filter housing 125 a male or female snap or tab 129 mates with a female or male snap or tab 119 on the face protector 110 as seen in FIGS. 7-9. In this embodiment the filter 130 may be placed in between the filter housing 125 and the face protector 110. Again, other connecting means 140 may be employed.

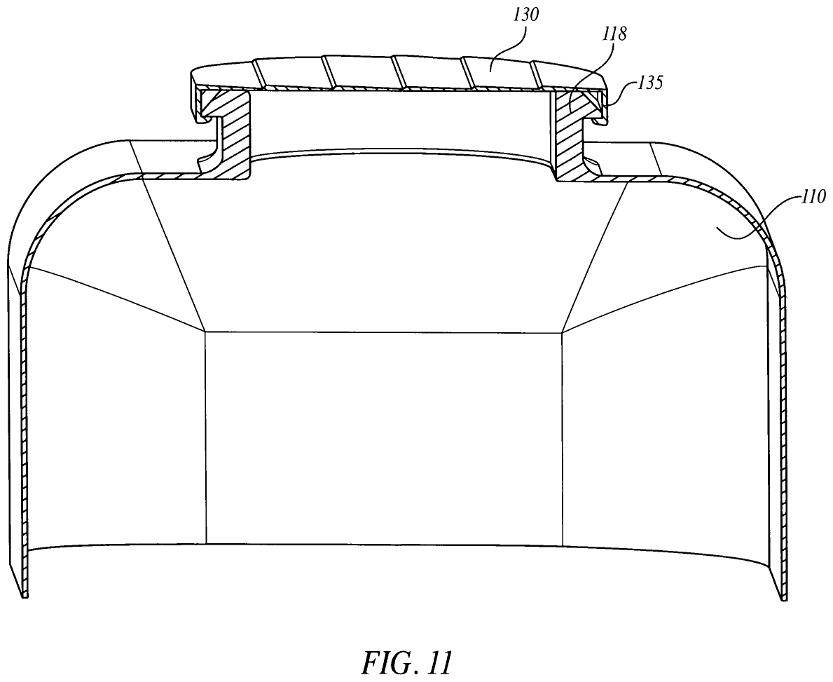

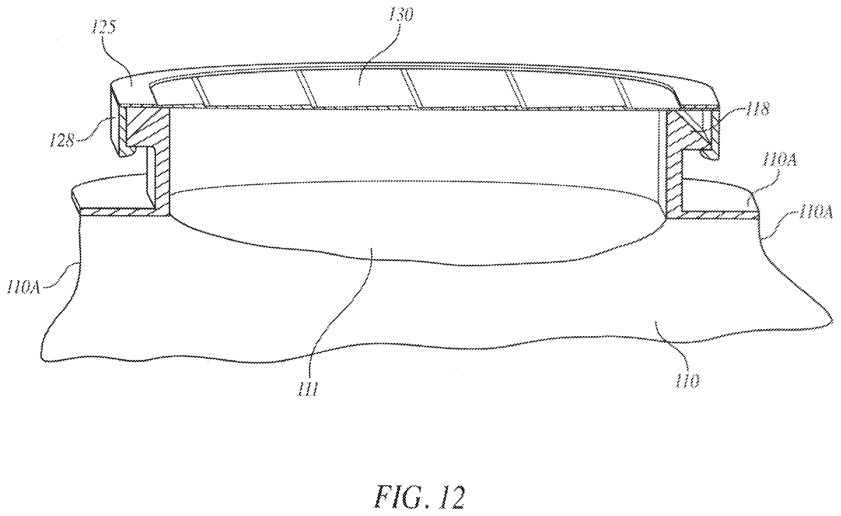

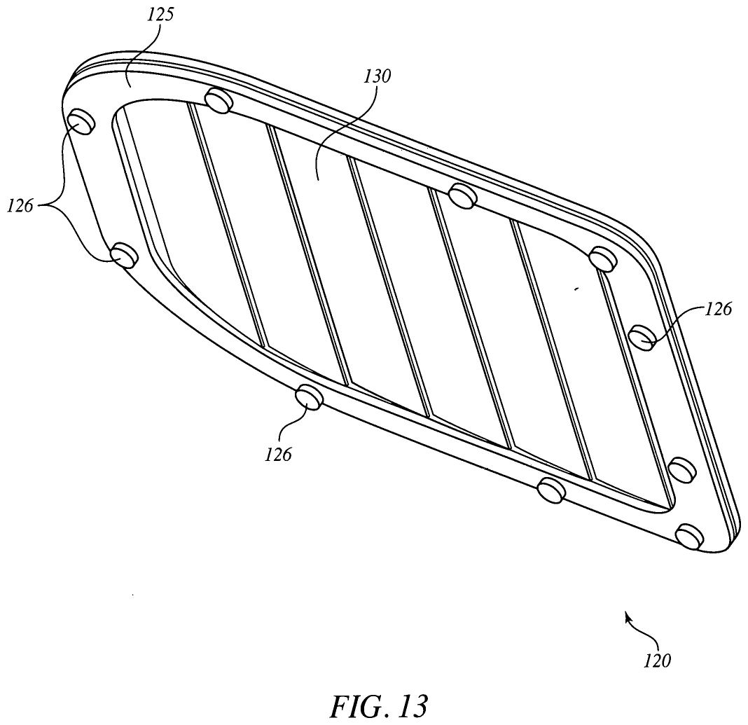

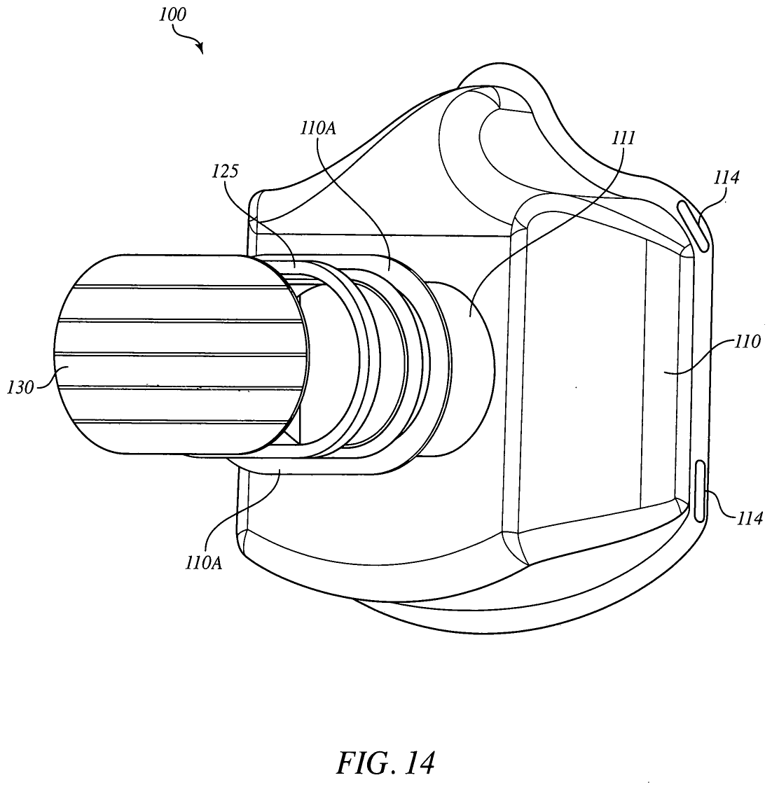

As seen in FIGS. 10-13, another embodiment of the inventive face mask 100 is shown where the connecting means 140 is filter 130 having a small overhang 135 inserted over and onto a tab 118 of the face protector 110. Another embodiment is shown in FIG. 13 where the connecting means 140 includes filter housing 125 having a number of tabs 126 to be inserted into openings (not shown) on the top and periphery of the mouth opening 111 of the face protector 110. FIG. 14 is another embodiment of the present invention of a reusable face mask 100 including a connecting means 140 such as snap-on filter housing 125 over the top of the face protector 110, namely on the portion 110A which is higher near the periphery of the mouth opening 111, and connects with the filter 130 in between.

The connecting means 140 should be joined together so that no gaps exist between the replaceable filter 120 and the face protector 110. This assist in keeping out the particulates from the inside of the mask such as pathogens, pollutants, virus, droplets and the like.

Other connecting means 140 may be employed such as shown in FIGS. 2-14 as long as the face mask 100 has a seal between the filter housing 125 and the face protector 110. Other connecting means include by way of example only clip on, snap on, snaps, threads, screws, lever press, pop-ins and pop-outs, and the like. There will be another connecting means between the securing means 150 and the face protector 100 which also must be tight to secure the inventive face mask 100 in a tight seal against the user's face.

The face protector 110 is connected to a securing means 150 for securing the inventive face mask 100 to the user's face. The securing means 150 may be straps or loop which encircle the user's ears or back of the head, or a set of ties to be tied together, buckled or joined in other ways behind the head of the user. As shown in FIG. 1, the securing means 150 are ear loops 151. The ear loops 151 may be made of any material which is comfortable to the user over a long period of time while the user wears the inventive face mask 100. The securing means 150 may be elastic to assist the user in place the securing means around the user's head or ears. Examples of materials for the ear loops 151 are woven materials such as elastic cotton or non-woven materials such as polymers and rubber. Other known elastic materials may be employed.

The securing means 150 should keep the face protector 110 tight against the face without gaps around the face protector 110. The securing means is connected to the face protector 110 via a connecting means 160 such as for example welding, adhesion, staples, snaps, O-rings, clips, threads, levers, lever presses, straps, screw, tabs, buckles, and the like. The securing means 150 can be connected to the face protector either permanently such as by weld, adhesion or staples or may be removable such as by snaps, tabs, screws or the like. The securing means 150 may be removeable and connected to the face protector 110 by hooking onto a series of tabs or hooks 116 (as seen in FIG. 4) or the like. The securing means 150 may be inserted into apertures or openings 114 on the periphery of the face protector 110 as shown in FIG. 14. The securing means 150 may be connected to the face protector 110 via for instance snap-in constructs configured to accommodate the insertion and extraction of various straps, cords, tubing, and/or O-ring stock. Certain snap-in constructs not shown and other straps not shown may be replaced and/or decontaminated and re-inserted. In other embodiments straps are open-ended to be tied behind the ears or the head or secured and adjusted via various cord lock systems. The straps or securing means 150 may have adjustments such as slides and other means to change and adjust the length of the straps so that the user has a tight-fitting mask 100. As seen in FIGS. 1, 7 and 9, ear loops or straps 150 are used to keep the face connector 110 properly positioned on the users head by connecting to hooks or tabs 118 on the side, relative to the mouth location, of the face protector 110.

In use, the wearer connects the filter 120 to the face protector 110 via the connecting means 140. The connecting means 140 may be tabs 141 on the underside of the filter housing 125 which are inserted into apertures or openings 115 on the face protector 110. The filter 130 is either already within the filter housing 125 or is inserted once the filter housing 125 is connected to the face protector 110. The user then places the face protector 110 over the person's nose and mouth making sure the sides of the face protector 110 are form-fitting or tight along the person's chin and cheeks without any gaps showing between the skin of the face and the face protector 110. The securing means 150 such as straps 151 are pulled over the wearer's ears or back of the head, assuming the securing means has already been connected to the face protector. The straps 151 or other securing means 150 may be adjusted to maintain the form-fitting element of the inventive face mask 100 against the face skin of the wearer. If the securing means 150 is not already connected to the face protector 110, then the user connects the securing means 150, such as straps 151 to another connecting means 160 such as for example hooks, tabs, or the like. Then the user would place the securing means 150 on the wearer's head to secure the inventive face mask 100 on the wearer.

The inventive face mask 100 may be cleaned, disinfected and/or sanitized for reuse by the wearer. The face protector 110 is made of a material capable of cleaning and sanitizing such as plastic or silicone. The filter housing 125 can be removed from the face protector 110 by popping out the tabs or clips, or pushing the level, or unhooking from the hooks, or any other de-sealing of the connecting means 140. The securing means 150 may be removed for cleaning, disinfecting, sanitizing or can be disposed of and new securing means 150 replaced. Thus, the inventive face mask 100 can be reused and is environmentally friendly compared to one-use disposable face masks such as surgical masks.

The inventive face mask 100 fills a need for a form-fitting reusable facemask that allows for changeable filters. The high-quality reusable mask 100 can utilize changeable and potentially less expensive filter material that is efficient enough to filter or prevent particles such as pollutant, virus, bacteria or liquids from getting through the inventive face mask 100. The inventive face mask 100 is environmentally friendly as the face protector 110 and filter housing 124 are reusable and not disposable. The inventive face mask 100 also combines both high-quality fit and low-cost changes of filtration materials.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

While the subject invention of the present disclosure has been described with respect to preferred and exemplary embodiments, those skilled in the art will readily appreciate that various changes and/or modifications can be made to the invention without departing from the spirit or scope of the invention as described herein. There have been described and illustrated herein several embodiments of the inventive face mask 100 and a method of operating same. While particular embodiments of the invention have been described, it is not intended that the invention be limited thereto, as it is intended that the invention be as broad in scope as the art will allow and that the specification be read likewise. Thus, while particular shapes and sizes of the face protector 110, filter 120 and securing means 150 and connecting means 140 have been disclosed, it will be appreciated that other shapes, sizes, and attachment means may be used as well. While certain filters 120 have been disclosed, any filter which can filter out particulates may be employed including without limitation construction grade or medical grade or OSHA grade filters and including without limitation those filters referred to as single ply material, 2-ply material, 3-ply material, N95, N99, N100, R95, R99, R100, P95, P99, and P100 mechanical filters. It will therefore be appreciated by those skilled in the art that yet other modifications could be made to the provided invention without deviating from its spirit and scope as claimed.

I claim:

1. A reusable face mask comprising:
a semi-flexible mask configured to cover a user's mouth, a nose, a portion of cheek and a portion of chin, having at least one aperture configured to open over the user's mouth;
a filter housing configured to be placed within the aperture on the semi-flexible mask;
a filter configured to fit within the filter housing;
a connecting means to connect the filter housing to the semi-flexible mask; and
a securing means to secure the reusable face mask to a user's head.

2. The reusable face mask of claim 1 wherein the semi-flexible mask is made of a polymer material.

3. The reusable face mask of claim 1 wherein the semi-flexible mask is made of silicone.

4. The reusable face mask of claim 1 wherein the filter comprises a material selected from woven fabric, non-woven materials, single ply materials, 2-ply materials, 3-ply materials, melt blown materials, or combinations thereof.

5. The reusable face mask of claim 1 wherein the filter comprises a material selected from the group consisting of N95, N99, N100, R95, R99, R100, P95, P99, and P100 mechanical filters.

6. The reusable face mask of claim 1 wherein the connecting means is selected from the group of snaps, O-rings, clips, threads, levers, lever presses, straps, screw, tabs, buckles, hooks, or combinations thereof.

7. The reusable mask of claim 1 further comprising a sealing means selected from the group consisting of O-rings and snaps.

8. The reusable mask of claim 1 wherein the securing means is selected from the group consisting of straps, ties, ear loops, elastic bands, or combinations thereof.

9. A reusable face mask comprising:
a soft silicone mask configured to cover a user's mouth, a nose, a portion of cheek and a portion of chin, having at least one aperture configured to open over the user's mouth;
a rigid filter housing configured to be placed within the aperture on the semi-flexible mask;
a multi-ply material filter configured to fit within the filter housing;
a snap connecting means to connect the filter housing to the semi-flexible mask; and
at least one strap to secure the reusable face mask to a user's head.

10. The reusable face mask of claim 9 further comprising a second strap to secure the reusable face mask to the user's head.

11. The reusable face mask of claim 9 wherein the at least one strap is a set of ear loops.

12. The reusable face mask of claim 9 wherein the filter comprises a material selected from woven fabric, non-woven materials, melt blown materials, 2-ply materials, 3-ply materials, or combinations thereof.

13. The reusable face mask of claim 9 wherein the filter comprises a material selected from the group consisting of N95, N99, N100, R95, R99, R100, P95, P99, and P100 mechanical filters.

14. A reusable face mask comprising:
a soft silicone mask configured to cover a user's mouth, a nose, a portion of cheek and a portion of chin, having at least one aperture configured to open over the user's mouth;
a rigid filter housing configured to be placed within the aperture on the semi-flexible mask;
a multi-ply material filter configured to fit within the filter housing;
at least one connecting means to connect the filter housing to the semi-flexible mask; and
at least one strap to secure the reusable face mask to a user's head.

15. The reusable mask of claim 14 wherein the at least one connecting means is a tab and opening configured for insertion of the tab into the opening.

16. The reusable mask of claim 14 wherein the at least one connecting means is a male and female set of tabs configured to mate and connect with each other.

17. The reusable face mask of claim 14 further comprising a second strap to secure the reusable face mask to the user's head.

18. The reusable face mask of claim 14 wherein the at least one strap is a set of ear loops.

19. The reusable face mask of claim 14 wherein the filter comprises a material selected from woven fabric, non-woven materials, melt blown materials, 2-ply materials, 3-ply materials, or combinations thereof.

20. The reusable face mask of claim 14 wherein the filter comprises a material selected from the group consisting of N95, N99, N100, R95, R99, R100, P95, P99, and P100 mechanical filters.
